(19) United States
(12) Patent Application Publication
(10) Pub. No.: US 2009/0246572 A1
(43) Pub. Date: Oct. 1, 2009

(54) METHOD AND A REACTOR FOR MAKING METHANOL

(75) Inventors: Olof Dahlberg, Vintrosa (SE); Alf Larsson, Karlskoga (SE)

Correspondence Address: PILLSBURY WINTHROP SHAW PITTMAN, LLP, P.O. BOX 10500, MCLEAN, VA, 22102, US

(73) Assignee: MORPHIC TECHNOLOGIES AKTIEBOLAG (PBL.), Karlskoga (SE)

(21) Appl. No.: 12/303,349

(22) PCT Filed: Jun. 14, 2007
(86) PCT No.: PCT/SE2007/050418

§ 371 Date: Mar. 10, 2009

(30) Foreign Application Priority Data
Jun. 16, 2006 (SE) 0601352-8

(51) Int. Cl. H01M 8/04; H01M 8/18

(52) U.S. Cl. 429/17; 429/21

(57) ABSTRACT

Methanol is produced from carbon dioxide and water in a reactor comprising a cathode side with a cathode and catalyst for the cathode reaction, an anode side with an anode and catalyst for the anode reaction, and an intermediate membrane separating the cathode side from the anode side. The reactor is divided into a plurality of cells that are flow connected in series for carrying out a multi-step cathode reaction. A voltage is connected between the cathode and the anode where the carbon dioxide is exposed to a cathode reaction, and is reduced to formic acid, in a second step the formic acid is reduced to formaldehyde and water, and in a third step the formaldehyde is reduced to methanol. Reduction of the amount of carbon dioxide to be deposited may be achieved. Water is oxidized to hydrogen peroxide, which may be used as oxidant in DMFC fuel cells.

### TECHNICAL FIELD

The present invention relates to a process for the production of methanol.

The invention also relates to a reactor of fuel cell type for use in the production of methanol from carbon dioxide and water, including a cathode side having a cathode and a catalyst for the cathode reaction, an anode side having an anode and a catalyst for the anode reaction, and an intermediate membrane separating the cathode side and the anode side.

### BACKGROUND ART

An increasingly growing field of use for methanol is as fuel in fuel cells, especially of DMFC type, where a large growth is expected on the motor vehicle side. From an environmental point of view, methanol is to be preferred over ethanol, which gives a considerably larger emission of carbon dioxide. Further, for a production of ethanol based on agriculture, a farming area is required that is four times larger than the forest area required for production of methanol by gasifying energy forest, which does not compete with the demand for wood of the forest industries.

Further, there are problems in neutralizing carbon dioxide formed through oxidation, carbon dioxide being a so called greenhouse gas. In thermal power stations, for example, carbon dioxide is produced on a large scale and it has been suggested to collect it and depose it in empty oil and gas fields, for example, preferably beneath the bottom of the sea. However, it is desirable to find suitable areas of use for the carbon dioxide to reduce the need for depositing it.

### DISCLOSURE OF THE INVENTION

The object of the present invention is to provide a process and a reactor, which by using carbon dioxide and water as starting materials in a synthesis will reduce the amount of carbon dioxide that has to be deposited.

In the process for production of methanol referred to in the introduction above, this object is achieved by connecting a voltage between a cathode and an anode of a reactor of fuel cell type, in a first step exposing carbon dioxide and water in the reactor to a first desired cathode reaction (a)

CO₂+2H₃O⁺+2e⁻→HCOOH+2H₂O (a)

while using a catalyst optimized for this reaction (a), conducting the reaction products from the first step to a second step, and there carrying out a second desired cathode reaction (b)

HCOOH+2H₃O⁺+2e⁻→HCHO+3H₂O (b)

while using a catalyst optimized for this reaction (b), and conducting the reaction products from the second step to a third step, and there carrying out a third desired cathode reaction (c)

HCHO+2H₃O⁺+2e⁻→CH₃OH+2H₂O (c)

while using a catalyst optimized for this reaction (c).

In the reactor referred to in the introduction above, this object is achieved in that the rector is divided into a plurality of reactor cells of fuel cell type with series connected flows for carrying out a multistage cathode reaction, wherein each cell has a catalyst that is optimized for the reaction step to be carried out in the cell.

By using the carbon dioxide for the production of methanol, which then with advantage can be used as fuel in fuel cells of DMFC type on the motor vehicle side, there is a possibility of achieving a considerable reduction of the amount of carbon dioxide that has to be deposited.

It is preferred to use a catalyst of Ag solely or together with TiO₂ and/or Te for the cathode reaction in the first step, a catalyst of SiO₂ and TiO₂ together with Ag for the cathode reaction in the second step, and a catalyst containing 60-94% Ag, 5-30% Te and/or Ru, and 1-10% Pt solely or together with Au and/or TiO₂, preferably in the proportions 90:9:1 for the cathode reaction in the third step. These catalysts are optimized to the desired reactions.

As reductant at the anode, it is preferred to use water together with a catalyst of carbon black, anthraquinone and Ag for the following anode reaction (d) in each step

4H₂O→H₂O₂+2H₃O⁺+2e⁻ (d).

In the reactor of the invention, this means that all cells suitably are designed to use a liquid reductant, and on the anode side all of the cells have a catalyst of carbon black, anthraquinone and Ag in phenolic resin for the use of water as liquid reductant and the production of hydrogen peroxide in the following anode reaction (d)

4H₂O→H₂O₂+2H₃O⁺+2e⁻ (d).

Thereby, the reactor will produce hydrogen peroxide as a by-product. Hydrogen peroxide is an extraordinary suitable oxidant to use in a fuel cell of DMFC type, as disclosed in our patent application filed simultaneously herewith and entitled A method in the operation of a fuel cell of DMFC type and fuel cell assembly of DMFC type, herewith incorporated by reference.

The three reaction steps preferably are carried out in three cells flow connected in series in the reactor, and the reactions on the cathode side and the anode side are maintained in stoichiometric balance with one another in each individual step. Hereby, the carrying out of the desired mechanism of reaction is facilitated.

The membrane preferably constitutes a carrier for the catalysts, both on the anode side and on the cathode side. In this way, a compact design and high power density is achieved.

It is suitable that that the cathode, the anode, and the membrane are thin plates that are attached to one another and have a thickness of less than 1 mm and a plane side, and that the membrane and at least one of the cathode and the anode on one side are provided with a surface structure, which produces an optimized flow of liquid over substantially the entire side of the plate.

It is also suitable that the surface structure is constituted by channels having a wave-shaped cross-section. Such channels are simple to make and make it possible to achieve the desired flow pattern.

The thin cathode and anode plates advantageously consist of sheet-metal having a thickness on the order of from 0.6 mm down to 0.1 mm, preferably 0.3 mm, and the channels have a width on the order of 2 mm up to 3 mm and a depth on the order of 0.5 mm down to 0.05 mm. Hereby, it is possible to reduce the dimensions of the reactor so that the power density increases, and simultaneously control the desired reactions.

Preferably, the membrane consists of glass, which suitably is doped to permit passage of protons/hydroxonium ions. In practice, a membrane of glass is insoluble in the reactants that are found in the cell and, consequently, is not attacked by them. Nor is it permeable for other ions.

Further, it is suitable that the membrane carries the catalyst for the concerned cathode reaction on it plane side and on its other side carries a silver mirror, which constitutes a catalyst for the anode reaction. Thereby, no separate carriers for the catalysts are necessary and the reactor cell may be made more compact.

### BRIEF DESCRIPTION OF THE DRAWINGS

In the following, the invention will be described in more detail with reference to preferred embodiments and the appended drawings.

FIG. 1 is a principle flow scheme illustrating a preferred embodiment of a reactor of fuel cell type, in which methanol is produced stepwise in reactor cells of fuel cell type from carbon dioxide and water.

FIG. 2 is a cross-sectional view of the reactor of FIG. 1 and shows a preferred arrangement of electrodes, intermediate membranes and flow channels.

FIGS. 3 and 4 are plan views of some different flow patterns for guiding the reactant flows in each cell.

### MODE(S) FOR CARRYING OUT THE INVENTION

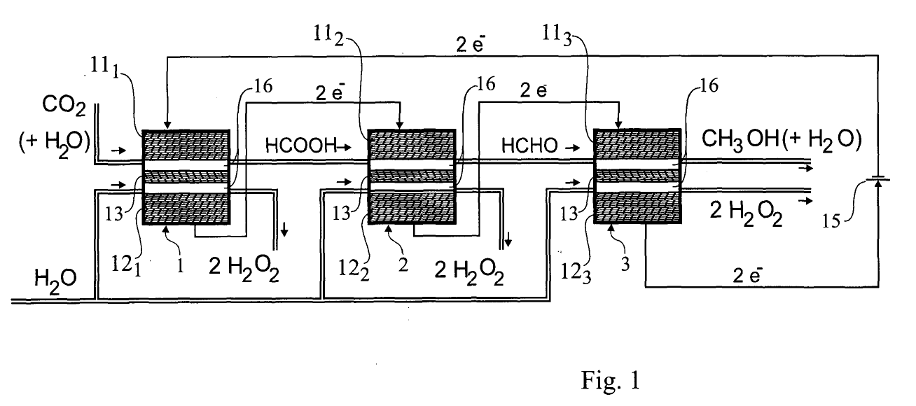

The principle flow scheme in FIG. 1 illustrates a preferred embodiment of a reactor of fuel cell type for use when producing methanol from carbon dioxide and water. The reactor includes a cathode side having a cathode 11 and a catalyst for a cathode reaction, an anode side having an anode 12 and a catalyst for an anode reaction, and an intermediate membrane 13 separating the cathode side and the anode side.

In accordance with the invention, the reactor is divided into a plurality of reactor cells 1, 2, 3 of fuel cell type with series connected flows for carrying out a multistage cathode reaction, in the shown embodiment three reactor cells, wherein each cell 1, 2, 3 has a catalyst that is optimized for the reaction step to be carried out in the cell.

To produce methanol, a voltage is connected between a cathode 11 and an anode 12 of a reactor of fuel cell type, and in a first step, carbon dioxide and water in cell 1 in the reactor is reduced to formic acid in a first desired cathode reaction (a)

CO₂+2H₃O⁺+2e⁻→HCOOH+2H₂O (a)

while using a catalyst optimized for this reaction (a), suitably Ag solely or together with TiO₂ and/or Te. The formed reaction products are conducted from the first step to cell 2 and a second step, where the formic acid is reduced to formaldehyde in a second desired cathode reaction (b)

HCOOH+2H₃O⁺+2e⁻→HCHO+3H₂O (b)

while using a catalyst optimized for this reaction (b), suitably SiO₂ and TiO₂ together with Ag, and the reaction products formed in the second step are conducted to a third cell 3 and a third step, where the formaldehyde is reduced to methanol in a third desired cathode reaction (c)

HCHO+2H₃O⁺+2e⁻→CH₃OH+2H₂O (c)

while using a catalyst optimized for this reaction (c), suitably containing 60-94% Ag, 5-30% Te and/or Ru, and 1-10% Pt solely or together with Au and/or TiO₂, preferably in the proportions 90:9:1.

By dividing up the production of the methanol from carbon dioxide and water into a plurality of steps, with catalysts optimized for each individual step, you can refine and control the desired reactions, so as to improve the degree of utilization and improve the power density.

In the embodiment shown in FIG. 1, fresh water supplied in each step will be oxidized electrochemically to hydrogen peroxide on the anode side in each step through the reaction

4H₂O→H₂O₂+2H₃O⁺+2e⁻ (d).

while using a catalyst of carbon black, anthraquinone, and Ag and phenolic resin. The supply of water to the various steps or cells 1, 2, 3 is suitably controlled so, that the reactions on the anode side and the cathode side are in stoichiometric balance with each other in each individual step. Thereby, the reactions can be refined more reliably and be controlled with conventional control equipment, not shown, so as to increase the yield. The production of hydrogen peroxide instead of oxygen gives the advantage of requiring much lower volumetric flows. Further, for air E⁰=1,227 V, while for hydrogen peroxide E⁰=1,766 V. In addition, it is an advantage to have liquid phase on both sides of the membrane.

Anthraquinone (CAS No. 84-65-1) is a crystalline powder having a melting point of 286° C., which is insoluble in water and alcohol, but soluble in nitrobenzene and aniline. The catalyst may be produced by mixing carbon black, anthraquinone and silver with phenolic resin, for example, and spreading it as a coating that is left to dry. Then, the coating is detached from the substrate, and after crushing and fine grinding the obtained powder is suspended in a suitable solvent, applied at a desired location and the solvent is evaporated.

The three reactor cells 1, 2, 3 also are electrically connected in series, Two electrons pass from a current source 15, shown as a battery, to the cathode 11₁ in step one, two electrons from the anode 12₁ in step one pass to the cathode 11₂ in step two, two electrons from the anode 12₂ in step two pass to the cathode 11₃ in step three, and from the anode 12₃ in step three, two electrons pass back to the current source 15. In all of the three cells 1, 2, 3, the formed protons/hydroxonium ions pass from the anode 12 through the membrane 13 to the cathode 11.

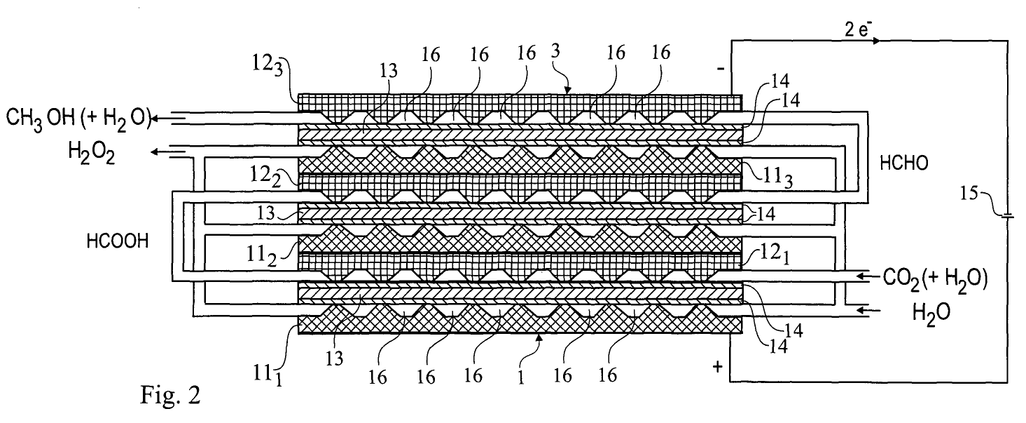

FIG. 2 is a cross-sectional view of the reactor assembly of FIG. 1 and shows a preferred arrangement of electrodes 11, 12, intermediate membranes 13 and flow channels 16. The cathodes 11, the anodes 12, and the membranes 13 are formed by thin plates attached to one another to form a pack or a stack. The joining may be carried out mechanically, e.g. by means of tension rods, not shown, but preferably joints, not shown, of a suitable glue are used, e.g. of silicon type, for keeping the plates together against one another. Between the membrane 13 and the cathode 11 and between the membrane 13 and the anode 12 a surface structure is provided, which promotes a substantially uniform flow of liquid over essentially the whole side of the plate. Further, FIG. 2 discloses that the electrical connection in series is so designed, that the one plate, which is anode 12₁ in step one, is in electrically conducting surface contact with the one plate, which is cathode 11₂ in step two, and that the one plate, which is anode 12₂ in step two, is in electrically conducting surface contact with the one plate, which is cathode 11₃ in step three. The flow conduits between the individual reactor cells 1, 2, 3 shown in FIG. 1 are formed in the plate pack/stack, but they are also shown in FIG. 2 as exteriorly located flow conduits.

The membrane 13 may be a conventional PEM membrane of Nafion™, but in a preferred embodiment, the membrane is a thin glass plate 13, which preferably is doped to permit migration of protons/hydroxonium ions from one membrane side to the other.

Advantageously, the glass consists of ordinary inexpensive glass grades, like soda lime glass and green glass. When such glass plates are made thin, their springiness and their specific load sustainability will increase. As doping agents in the glass, a plurality of various metals are possible, but preferably silver in form of silver chloride is used, which is comparatively inexpensive. The doping agent as well as the small thickness of the glass facilitates the migration of protons/hydroxonium ions through the membrane. Further, the glass will prevent the passage of other ions and molecules and, as it is not electrically conductive, electrons can not pass from the anode 12 through the membrane 13 to the cathode 11.

In the preferred embodiment shown in FIG. 2, the cathode 11, the anode 12, and the membrane 13 have a thickness of less than 1 mm. The cathode 11 and the anode 12 have a plane side, and said surface structure 16, which produces an optimized flow of liquid over substantially the entire side of the plate, is provided on the cathode 11 and the anode 12, while both sides of the intermediate membrane 13 are plane. The plane side of the anode 12₁ in cell 1 in the reactor assembly shown in FIG. 1 then is in electrically conductive bearing contact with the plane surface of the cathode 11₂ in cell 2, and so on. It is obvious that a reactor cell 1, 2, 3 may have a cathode 11, a membrane 13, and an anode 12, all of which have a plane side facing a side provided with a surface structure 16 on an adjacent plate, or vice versa, or a cathode 11 and an anode 12 having plane sides facing the membrane 13, the two sides of which are provided with surface structure 16.

The cathode 11 and the anode 12 suitably are thin metal sheets of electrically conductive material resistant to the reactants, e.g. stainless steel, having a thickness from on the order of 0.6 mm down to 0.1 mm, preferably 0.3 mm. Possible surface structure 16 in the membrane 13 as well as the surface structure in the cathode 11 and the anode 12 may consist of channels having a wave-shaped cross-section. The channels suitably have a width on the order of 2 mm up to 3 mm and a depth from on the order of 0.5 mm down to 0.05 mm. In the glass membrane 13 a possible surface structure 16 is provided by etching, for example, and in the cathode and anode plates 11, 12 it is produced by adiabatic forming, also called high impact forming. For example, the forming can be achieved in the way disclosed in U.S. Pat. No. 6,821,471. Plates having a desired surface structure or flow pattern and produced by high impact forming cost only about one tenth of what plates in which the flow pattern was produced by cutting operation would cost.

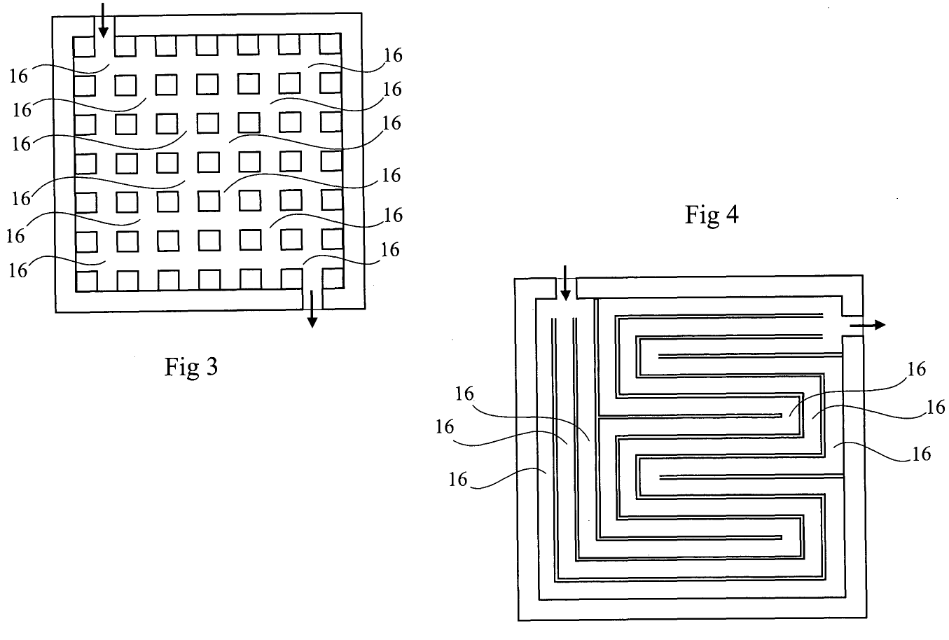

FIGS. 3 and 4 show some different surface structures or flow patterns 16, which produce an optimized flow of liquid over substantially the entire side of the plate. In FIG. 3, parallel channels are repeatedly broken through laterally, so that the entire surface structure consists of pins arranged in a diamond pattern, forming a grid-shaped system of channels 16. Finally, FIG. 4 shows that also parallel serpentine channels 16 may be used. In all cases where different flow paths are possible, equal lengths from inlet to outlet should be aimed at.

Preferably, the glass plate 13 has a plane side, and the plane side suitably is provided with a catalyst that is necessary for carrying out an anode reaction or a cathode reaction in the fuel cell or reactor, and advantageously the catalyst is fused onto the glass surface on the other side of the membrane. Then, it is also suitable that the other side of the glass plate 13 is plane, and that a catalyst that is necessary for carrying out the cathode reaction or anode reaction is fused onto the glass surface on the other side of the membrane. As illustrated in FIG. 2, where incidentally the membranes 13 are shown as being provided with a catalyst layer 14 on both sides, this facilitates the construction of a compact stack of reactor cells 1, 2, 3 having electrodes 11, 12 of the same, thin plate shape with one plane side and one surface structured side, whereby a high power density may be achieved.

As mentioned above, the catalyst promoting the reaction in the second step suitably consists of SiO₂, TiO₂ and Ag. When the membrane 13 consists of glass, there already is SiO₂ in the glass, and consequently only TiO₂ and Ag have to be applied separately.

By suitably being fused onto the surface of the glass, the catalyst is protected against mechanical damage, simultaneously as the compact construction that gives a high power density is maintained. The fusion is carried out by laser, for example, suitably in an inert atmosphere, and before the fusion the catalyst particles as a matter of course should be made very small, e.g. by grinding in a ball mill, in order to increase the catalyst area.

Naturally, catalysts may be carried also by one or both of the electrodes 11, 12. Alternatively, at least one of the catalysts, e.g. the one that contains anthraquinone and silver, may be arranged in an intermediate, separate carrier of carbon fiber felt, for example, not shown. However, such an arrangement will cause the diffusion to slow down, so this variant is less preferred even though it is possible.

1. A process for the production of methanol, comprising connecting a voltage between a cathode and an anode of a reactor of fuel cell type,
in a first step (1), exposing carbon dioxide and water in the reactor to a first desired cathode reaction (a)
CO₂+2H₃O⁺+2e⁻→HCOOH+2H₂O (a)
while using a catalyst optimized for this reaction (a),
conducting the reaction products from the first step (1) to a second step (2), and there carrying out a second desired cathode reaction (b)
HCOOH+2H₃O⁺+2e⁻→HCHO+3H₂O (b)
while using a catalyst optimized for this reaction (b), and
conducting the reaction products from the second step (2) to a third step (3), and there carrying out a third desired cathode reaction (c)
HCHO+2H₃O⁺+2e⁻→CH₃OH+2H₂O (c)
while using a catalyst optimized for this reaction (c).

2. A process as claimed in claim 1, further comprising using a catalyst of Ag solely or together with TiO₂ and/or Te for the cathode reaction in the first step.

3. A process as claimed in claim 1 further comprising using a catalyst of SiO₂ and TiO₂ together with Ag for the anode reaction in the second step.

4. A process as claimed in claim 1, further comprising using a catalyst containing 60-94% Ag, 5-30% Te and/or Ru, and 1-10% Pt solely or together with Au and/or TiO₂, for the anode reaction in the third step.

5. A process as claimed in claim 1, further comprising using water as a reductant at the anode together with catalyst of carbon black, anthraquinone and Ag for the following anode reaction (d) in each step (1-3)
4H₂O→H₂O₂+2H₃O⁺+2e⁻ (d).

6. A process as claimed in claim 1, further comprising carrying out the three reaction steps in three cells with series connected flows in the reactor.

7. A process as claimed in claim 1, further comprising maintaining the reactions on the anode side and the cathode side in stoichiometric balance with one another in each individual step.

8. A reactor of fuel cell type for use in the production of methanol from carbon dioxide and water, including a cathode side having a cathode and a catalyst for the cathode reaction, the anode side having an anode and a catalyst for an anode reaction, and an intermediate membrane separating the cathode side and the anode side, characterized in that the rector is divided into a plurality of reactor cells of fuel cell type with series connected flows for carrying out a multistage cathode reaction, wherein each cell has a catalyst that is optimized for the reaction step to be carried out in the cell.

9. A reactor as claimed in claim 8, on the cathode side, the first cell has a catalyst of Ag solely or together with TiO₂ and/or Te for carrying out the following cathode reaction (a)
CO₂+2H₃O⁺+2e⁻→HCOOH+2H₂O (a)
the second cell has a catalyst of SiO₂ and TiO₂ together with Ag for carrying out the following cathode reaction (b)
HCOOH+2H₃O⁺+2e⁻→HCHO+3H₂O (b)
and the third cell has a catalyst containing 60-94% Ag, 5-30% Te and/or Ru, and 1-10% Pt solely or together with Au and/or TiO₂, for carrying out the following cathode reaction (c)
HCHO+2H₃O⁺+2e⁻→CH₃OH+2H₂O (c).

10. A reactor as claimed in claim 9, wherein all the cells are designed for using a liquid reductant.

11. A reactor as claimed in claim 10, wherein, on the anode side, all cells have a catalyst of carbon black, anthraquinone and Ag for the use of water as liquid reductant and production of hydrogen peroxide in the following anode reaction (d)
4H₂O→H₂O₂+2H₃O⁺+2e⁻ (d).

12. A reactor as claimed in claim 8, wherein the membrane is a carrier for the catalysts on the cathode side and/or the anode side.

13. A reactor as claimed in claim 8, wherein the cathode, the anode, and the membrane are thin plates that are attached to one another and have a thickness of less than 1 mm, both sides of the membrane being plane, and the cathode and the anode having one plane side and an opposed side that faces the membrane, and is provided with a surface structure, which produces an optimized flow of liquid over substantially the entire side of the plate.

14. A reactor as claimed in claim 13, wherein the surface structure is composed of channels having a wave-shaped cross-section.

15. A reactor as claimed in claim 14, wherein the thin cathode and anode plates comprise sheet-metal having a thickness between about 0.6 mm and about 0.1 mm and the channels have a width between about 2 mm and about 3 mm, and a depth between about 0.5 mm and about 0.05 mm.

16. A reactor as claimed in claim 8, wherein the membrane consists of glass.

17. A reactor as claimed in claim 16, wherein the glass is doped to permit passage of protons/hydroxonium ions.

18. A process as claimed in claim 1, further comprising using a catalyst containing approximately 90% Ag, 9% Te and/or Ru, and 1% Pt solely or together with Au and/or TiO₂, for the anode reaction in the third step.

19. A reactor as claimed in claim 9, wherein the catalyst of the third cell containing has a catalyst containing approximately 90% Ag, 9% Te and/or Ru, and 1% Pt solely or together with Au and/or TiO₂.
